(19) United States
(12) Patent Application Publication
(10) Pub. No.: US 2026/0096508 A1
(43) Pub. Date: Apr. 9, 2026

(54) SYSTEMS AND METHODS FOR CONTROLLING THE PERFORMANCE OF A HEADER SEVERING SYSTEM

(71) Applicant: DEERE & COMPANY, Moline, IL (US)

(72) Inventors: Scott N. Clark, Bettendorf, IA (US); Duane M. Bomleny, Geneseo, IL (US); Justin Cody Freehill, Fenton, IL (US); Scott E. Faulkner, Orion, IL (US); Nathan R. Vandike, Geneseo, IL (US)

(21) Appl. No.: 18/909,659

(22) Filed: Oct. 8, 2024

(51) Int. Cl. A01D 41/127; A01D 41/14; A01D 90/04

(52) U.S. Cl. CPC A01D 41/1274; A01D 41/141; A01D 90/04

(57) ABSTRACT

A system and method for controlling the performance of a severing system of an agricultural machine for cutting crop material. Information obtained at or around a cutterbar assembly of the severing system by a cutter sensor(s) can be used to identify an occurrence of a trigger condition. A machine learning model of a neural network can use at least a characteristic of the trigger condition, among other information regarding crop, environmental, and/or machine attributes and operator preferences, to identify one or more corrective actions. Once the corrective actions are automatically, semi-automatically, and/or manually implemented, the effectiveness of the corrective actions can be evaluated using feedback information, including feedback information representative of a cut quality being obtained by the cutterbar assembly. The effectiveness of the implemented corrective action(s) can be further be used by the neural network to train or retrain the machine learning model of the neural network.

### FIELD OF THE DISCLOSURE

The present disclosure generally relates to controlling header cutting operations, and, more specifically, to controlling the cutting performance of a severing system of a harvester.

### BACKGROUND

Agricultural harvesters, such as, for example, combine harvesters, can include different portions or sections for cutting and processing crops. For example, certain types of combines harvesters include headers, such as, for example, draper headers, that can include a reel that gathers crop material to be severed by the cutting apparatus and conveyed by a plurality of draper belts of the draper header. The draper belts can then transport the crop material laterally inwardly and rearwardly to a feederhouse of the harvester for processing by the harvester.

### SUMMARY

The present disclosure may comprise one or more of the following features and combinations thereof.

In one embodiment of the present disclosure, a system is provided for controlling a performance of a severing system of an agricultural machine for cutting a crop material. The system can include a severing system having a cutterbar assembly having a plurality of knives that can be configured for a reciprocal movement to cut the crop material. The system can also include a sensor system that can include a cutter sensor that is configured to obtain a first information regarding the performance of the severing system. Additionally, the system can include at least one processor and at least one memory. The at least one memory device can store instructions that, when executed by the at least one processor, can cause the system to compare the first information to a predetermined threshold to identify an occurrence of an trigger condition, and receive, in response to the occurrence of the trigger condition, one or more corrective actions, the one or more corrective action identified based on at least one or more characteristics of the trigger condition. Further, the at least one memory device can store instructions that, when executed by the at least one processor, can cause the system to generate a control signal to implement at least one corrective action of the one or more corrective actions.

In another embodiment of the present disclosure, a method is provided for controlling a performance of a severing system of an agricultural machine for cutting a crop material. The method can include receiving a sensor data from a sensor system corresponding to the performance of the severing system, and comparing the received sensor data to a predetermined threshold to identify an occurrence of a trigger condition. Additionally, the method can include identifying, one or more corrective actions based on at least one or more characteristics of the trigger condition, issuing a control signal to implement at least one corrective action of the one or more corrective actions.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a side view of an exemplary agricultural machine in the form of a combine harvester having an exemplary header in the form of a draper belt header.

FIG. 2 illustrates a top view of a front portion of the combine harvester shown in FIG. 1.

FIG. 3 illustrates a top side perspective view of a portion of an exemplary cutterbar assembly.

FIG. 4 illustrates an exploded view of a portion of an exemplary support assembly for knives and knife guards of a cutterbar assembly of a severing system.

FIG. 5 illustrates a bottom view of a portion of an exemplary drive system for a severing system of a header.

FIG. 6 illustrates a simplified block diagram of an exemplary cutting performance control system for controlling the cutting performance of a severing system of a harvester.

FIGS. 7A and 7B illustrate a simplified flow diagram of an exemplary method of using a cutting performance control system for controlling at least the cutting performance of a severing system of an agricultural machine.

FIG. 8 illustrates a graph representing sensed noise data transformed to the frequency domain that indicates a presence of an anomaly indicative of an occurrence of knife hammering.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Embodiments of the present disclosure generally relate to monitoring the performance of a severing system, or parts thereof, in connection with cutting a crop in a field that is being harvested by an agricultural machine. Additionally, embodiments of the present disclosure generally relate to identifying potential anomalies or deviations from anticipated performance of the severing system, and determining, based on characteristics of the anomaly(ies), among other factors, what, if any, remedial actions are to be automatically, semi-automatically, or manually implemented.

In at least certain situations, debris and/or changes in field, crop, and/or machine attributes, among other circumstances, can adversely impact operation of an agricultural operation being performed by at least the header. For example, situations can arise that can result in an interference with a movement of at least certain components of the header. Such interferences in movement not only can adversely impact the productivity of the associated agricultural operation being performed by the header, but can also result in one or more components of the header being subjected to excessive, and potentially damaging, forces. Further, various crop and/or field attributes, blockages, and/or a condition of components of the severing system, can contribute to a degradation in the performance of at least a cutterbar assembly of the severing system in cutting crops during a harvesting operation.

Such performance degradation, which can include, but is not limited to, slips or stalls of an associated drive system and/or a decline in a quality of the cut, also referred to as a cut quality, of crop cut by an associated cutterbar assembly can be identified in a variety of manners. For example, an occurrence of a trigger condition can be identified, for example, via detecting vibration or noise levels at or around at least knives of the cutterbar assembly, among at other locations, that are outside of anticipated levels. Such anomalies in the detected vibrations or noise levels, among other types of sensed or captured information, can be used, for example, by a machine learning model(s), including deep learning models and adaptive learning models, among others, of a neural network to identify an occurrence, including presence, of a trigger condition. Additionally, or alternatively, at least certain characteristics of the identified trigger condition can be used by a machine learning model of the neural network to identify a particular type of trigger condition associated with the detected anomalies, including, for example, a hammering of the knives of the cutterbar assembly or a stagnation in the reciprocal movement of the knives, among other types of trigger conditions. Additionally, or alternatively, such machine learning models can, based on characteristics associated with the identified anomaly(ies), be used to identify one or more corrective actions that may automatically, semi automatically, or manually be implemented to adjust an operation of the agricultural machine, including the severing system, to at least attempt to remediate the trigger condition and/or improve the cut quality attained by the severing system in view of the occurrence, including at least temporary presence, of the trigger condition. The type of trigger condition can, however, be determined in a variety of other manners in addition to, or in lieu, of use of a machine learning model, including a deep learning or generative model. For example, with respect to certain embodiments, the system disclosed herein can be configured to identify one or more trigger event types using sensed or captured information regarding an operation(s) of one or more portions of the severing system in view of embedded lookup tables, predetermined threshold/trigger values, and/or a pretrained model, among other manners of identifying a trigger condition type.

The effectiveness of such a corrective action(s), if implemented, can be evaluated using information obtained by one or more feedback sensors. For example, feedback information can be utilized to evaluate the impact one or more implemented corrective actions have had on the cut quality being attained via operation of the cutterbar assembly of the severing system. According to such an embodiment, such feedback information can be evaluated in connection with one or more predetermined feedback thresholds to determine whether the implemented corrective action should be adjusted, including, for example, replaced with one or more other corrective actions. Additionally, such feedback information, including any determined effectiveness associated with the implemented corrective action(s) can be used by the neural network in connection with continuous training of the machine learning model.

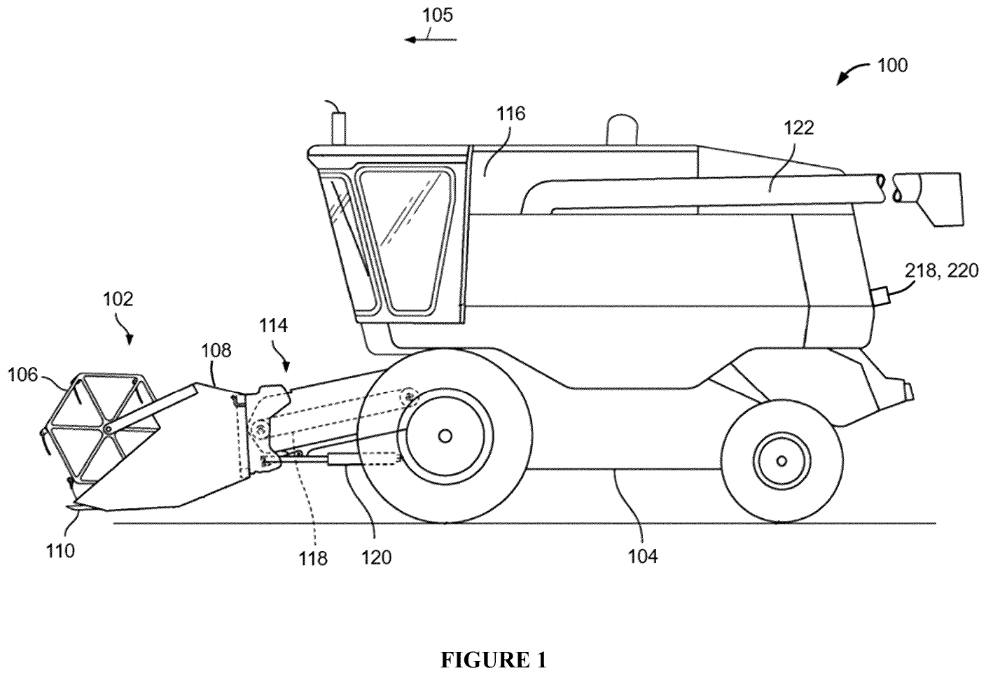

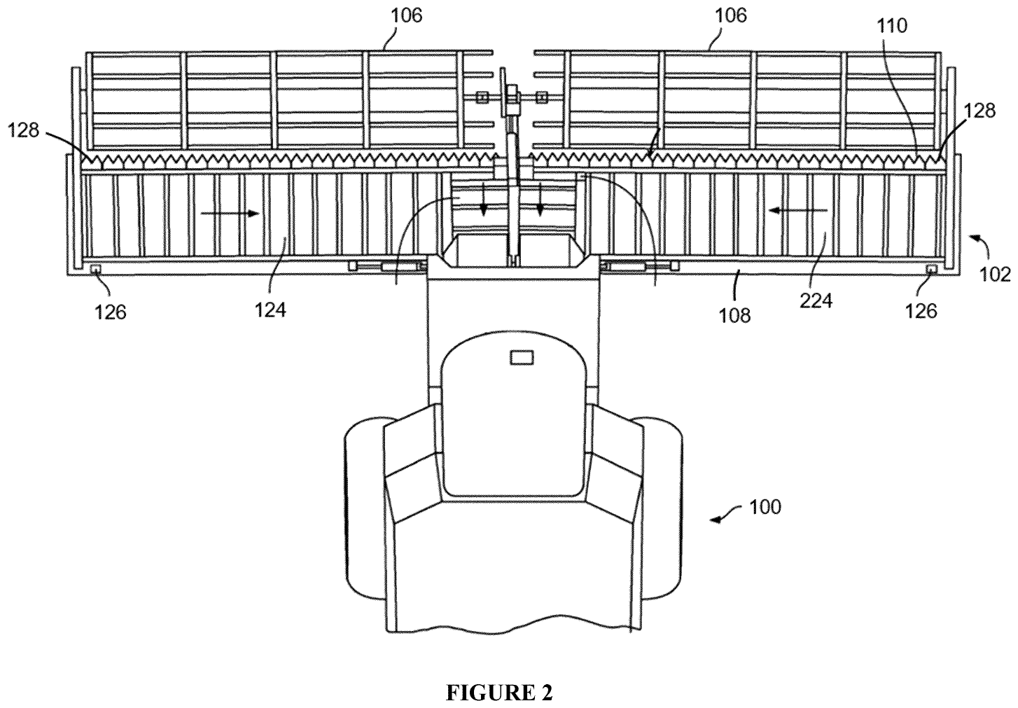

FIGS. 1 and 2 illustrate front and top side views, respectively, of an exemplary agricultural machine 100 in the form of a combine harvester having a non-limiting example of a particular type of header 102 in the form of a draper belt header. While, for at least purposes of illustration, embodiments discussed herein may reference a particular type of agricultural machine 100 and header 102, as well as particular types of crop material, such as, for example, soybeans or wheat, it is understood that the agricultural machine 100 and associated header 102 can be configured to harvest variety of other crop materials, including grain and non-grain materials such as, but not limited to, sunflower, wheat, barley, rye, rice, corn, soy, and canola, among other types of crop material.

The header 102 is coupled to a chassis 104 and positioned to remove crop material from the ground. The header 102 includes a reel 106 to draw crop material into the header 102. The reel 106 can be selectively movable relative to a frame or bearing frame 108 of the header 102 during use of the agricultural machine 100. The header 102 can also include a severing system 110 that is adapted to cut, or otherwise sever, crop so that the cut crop material can be removed from a field while other, stubble portions of the crop at or below the location at which the severing system 110 cut the cut crop can remain in the field. Additionally, the header 102 is configured to direct the crop material that has been cut by the severing system 110 to a feederhouse 114. The cut crop material can then be separated from the non-crop material, cleaned, and transported to a grain tank 118. Although not shown in FIG. 1, it should be appreciated that the agricultural machine 100 at least partially houses a number of devices or systems in an interior thereof, such as one or more threshing device(s), separating device(s), and cleaning device(s), among others. Further, the agricultural machine 100 at least partially defines a tank 120 that may be used to store cleaned crop materials (e.g., grain) prior to removal and unloading of the cleaned crop materials onto a transport vehicle by an unloading conveyor 122.

The header 102 can include one or more conveyors 116, 124 to convey crop material, and, more particularly the cut crop material, along the header 102. For example, the exemplary header 102 shown in at least FIG. 2 includes two side belts 124, each positioned above a wing portion 132, 134, and which are connected to a driver 126 that provides power for the rotational displacement of the side belts 124. The wing portions 132, 134 can be pivotably displaceable relative to a center platform 136 about which a central belt conveyor 116 is positioned. Accordingly, during harvesting of the crop material, power provide by the driver 126 can be transmitted to the each of the two side belts 124 such that the top sides of the side belts 124 move inwardly (i.e., as shown by the arrows in FIG. 2) so as to convey cut crop material captured by the reel 106 and severed by the severing system 110 to the center of the header 102. Crop material conveyed to the center of the header 102 is then conveyed on a belt of the central belt conveyor 116, that can also be driven by the driver 126, and transported rearwardly into a feederhouse 114.

The feederhouse 114 can be pivotably displaced by an actuator 120 relative to the chassis 104 about an axis which extends horizontally and transversely to a forward direction of travel (as generally indicated by arrow 105) of the agricultural machine 100. In some embodiments, the height of the header 102 relative to the ground can be adjusted via selective activation of the actuator 120.

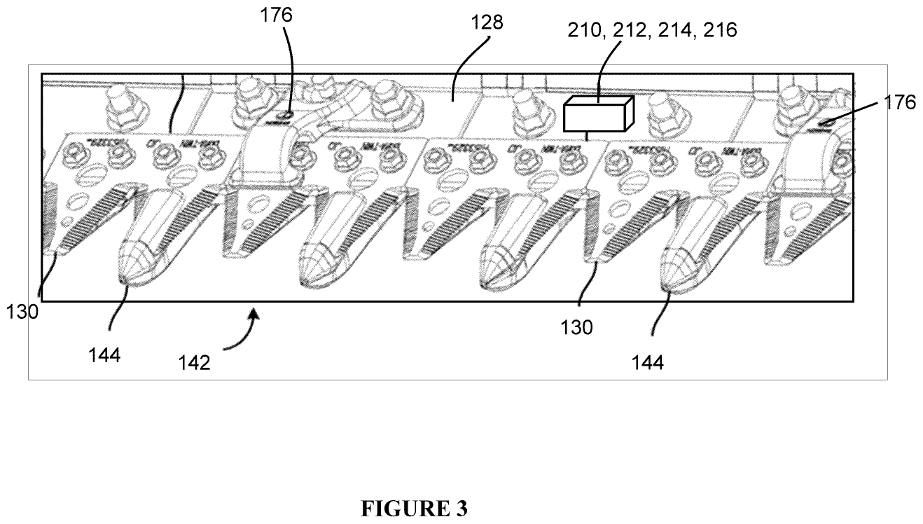

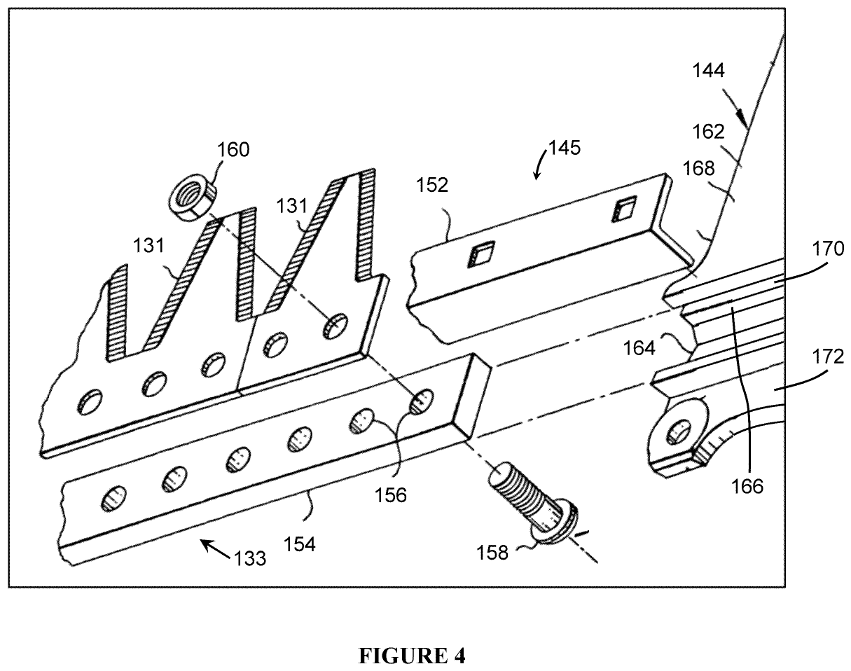

The header 102 can include a severing system 110 that can include a cutterbar assembly 142 having one or more cutterbars 128 that can, for example, be carried by float arms that are coupled to the frame 108. As seen by at least FIGS. 3 and 4, a plurality of knife guards 144 can be positioned in opposition to the knives 130 to provide opposing surfaces for the cutting of the crop material with knives 130. The cutterbar 128 can be formed from a metal which is flexible to an extent allowing a desired degree of flexure across the width of header 102. In the illustrated embodiment, a majority of each cutterbar 128 is carried by the wing portions 132, 134 of the header 102, with a lesser extent at the adjacent inboard ends of each cutterbar 128 being carried by the center platform 136. Each cutterbar 128 can be coupled to a plurality of knives 130 that can be carried by a support bar 154 (FIG. 4). The particular type of knife 130 can vary, such as, for example, with respect to knife shape and severing or edge geometry, as well as be a double blade knife or a single blade knife, among other variations.

The cutterbar assembly 142 can also include a support system 145 for supporting and securing at least the knives 130 and knife guards 144 to the cutterbar 128. The support system 145 can include one or more support bars 152 to which one or more of the knife guards 144 can be mounted. With respect to the knives 130, the support system 145 can include one or more elongated knife backs 154 that can include a series of knife mounting holes 156. A series of knife sections 131 of the knives 130, two of which are illustrated, can be bolted to the knife back 154 by mounting bolts 158 and nuts 160. The support bar 152 and the knife back 154 extend transversely to the travel direction of the agricultural machine 100. The support system 145 can also include one or more hold downs 176 that can assist in guiding the reciprocal movement of the knives 130 and/or limit displacement of the knives 130 in at least the vertical direction.

The knife guards 144 can include a body portion 162 that can be configured to include a channel 164 for receiving an adjacent portion of a knife back 154. The body portion 162 can, for example, be formed by a lower section 166 and an upper section 168 of the knife guard 144. The lower and upper sections 166, 168 can be spaced relative to one another to define a horizontal knife slot 170 therebetween, within which an adjacent knife section 131 is confined and moveable. Additionally, the upper and lower sections 166, 168 can be coupled to one another at the forward end of the guard body portion 162. The support structure 145 can further include a mounting portion 172 that can, for example, be integrally formed with the body portion 162 and extend rearwardly therefrom, behind the channel 170, for mounting the knife guard 144 to the support bar 152.

The severing system 110 can also include a drive system 138 having one or more drivers 140 that can generate a force used to operate at least a portion of the cutterbar assembly 142, including, for example, facilitate coordinated movement of the two cutterbars 128, and thus the associated knives 130, in reciprocating, opposite directions. A variety of different types of actuators or drivers can be utilized as the driver 140, such as, for example, an engine or motor, including an electric motor, or hydraulic motor, hydraulic cylinder(s), or pneumatic cylinder(s), as well as any associated hydraulic or pneumatic pump, among others. With respect to at least certain types of drive systems 138, the drive system, 138 can also include a drive shaft 150 that can be coupled to the driver 140 and configured to transmit power generated by operation of the driver 140. Further, in certain instances, the driver 140 can be a common driver wherein the drive shaft 150 is coupled to a plurality of components of the drive system 138 for either or both direct and indirect transmission of power from the driver 140. The driver 140 can also be operated in a first, or forward direction, and a second, reverse direction, the second, or reverse, direction being opposite of the first direction. According to certain embodiments, while the agricultural machine 100 is being operated in a manner that at least collects crop material for delivery of the cut crop material to the feederhouse 106, the driver 138 can be operated in the first, or forward direction.

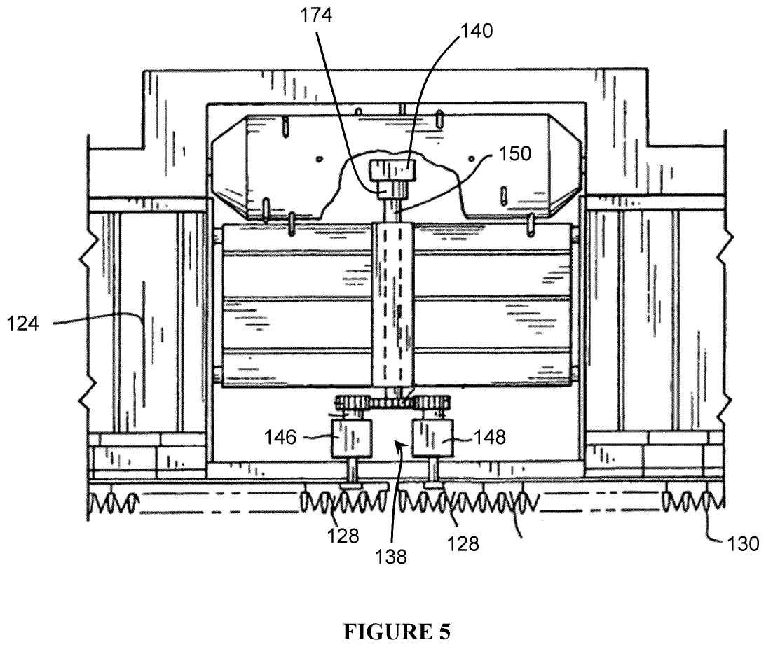

FIG. 5 illustrates an example of a drive system 138 having a single driver 140, such as, for example, an electric motor or electrically driven linear actuator, for driving the pair of cutterbars 128. The illustrated drive system 138 includes gearboxes 146, 148 which are respectively coupled with and reciprocally drive the pair of cutterbars 128. The input drive shaft 150 can directly, or indirectly, transmit the rotational force outputted from the driver 140 to the gearboxes 146, 148. In the illustrated embodiment, the gear boxes 102 and 104 can be reciprocally driven in a timed and oppositely reciprocating manner such that the cutterbars 128 move in opposite directions relative to each other.

Although a particular type of drive system 138 is depicted in FIG. 5, a variety of other types drive systems 138 can be utilized to drive the reciprocal movement of the cutterbars 128. For example, as seen in FIG. 5 and discussed above, according to certain embodiments, the drive system 138 can be a mechanical drive system that utilizes an engine or motor and an associated drive shaft 150 for the transmission of rotational power that can be used in connection with driving the reciprocal movement of the cutterbars 128. Alternatively, according to other embodiments, the drive system 138 can be a mechanical drive system in which power generated by the driver 140 is transmitted to one or more pulleys there are a coupled to a belt, such as, for example, a V-belt, that can be displaced in a manner that may rotate one or more other pulleys that are directly or indirectly coupled to the gearboxes 146, 148. Alternatively, according to other environments, rather than being a mechanical drive system, the drive system 138 can be hydraulically or pneumatically driven. For example, according to certain embodiments, the driver 140 can, for example, include one or more pneumatic or hydraulically-operated actuators or cylinders, as well as combinations thereof, among other devices, that can be utilized to directly or indirectly facilitate the reciprocal movement of the cutterbars 128. Thus, for example, one or more of the drivers 140 can be a double-acting hydraulic or pneumatic cylinder that is extendable and retractable to vary a length thereof. Such drive systems 138 can thus further include one or more associated pumps, motors, or control valves, as well as various combinations thereof, among other devices, that are utilized in controlling the selective extension and retraction of such actuators.

The drive system 138 can also include an overload release body 174 that can be configured to prevent components of the drive system 138 from experiencing damage associated with the drive system 138 being subjected to excessive torques, among other forces or pressure. For example, referencing the embodiment illustrated in FIG. 5, the overload release body 174 can be a slip clutch that can be directly or indirectly coupled to the driver 140 and/or the drive shaft 150. Thus, while FIG. 5 illustrates an embodiment in which the overload release body 174 is positioned between the driver 140 and the input shaft 150, according to other embodiments the overload release body 174 can be positioned between the drive shaft 150 and other components of the drive system 138.

In certain instances, a blockage can interfere with, if not prevent, the reciprocal movement of the cutterbars 128, and thus of the knives 130. Such blockages can, for example, be attributed to an excessive presence or accumulation of crop material or debris, including, for example, rocks and posts, among other debris, being positioned, for example, between the knives 130 and knife guards 144. Despite the interference, or stoppage, in the reciprocal movement of the knives 130, the driver 140 can continue to seek to maintain the outputted rotational power that is to be transmitted through the drive shaft 150. Thus, the resistance or interference created by the blockage against the reciprocal movement of the knives 130 as the driver 140 seeks to continue operation can potentially expose components of at least the drive system 138 to excessive, and potentially damaging, levels of torque. An overload release body 174 in the form of a slip clutch 130 however can be configured such that when torque levels reach a certain level, such as, for example, levels associated with a blockage in the reciprocal movement of the knives 130, the slip clutch is triggered in a manner in which the slip clutch slips or spins free so as to stop the transfer of power to other components of the drive system 138. Accordingly, in such an event, the overload release body 174 can protect components of at least the drive system 138 from damage associated with being exposed to excessive torques.

While the foregoing is discussed in terms of the overload release body 174 being a slip clutch, the overload release body 174 can, for different types of drive systems 138, have different configurations. For example, according to embodiments in which the driver 140 is a pneumatic or hydraulic cylinder(s), the overload release body 174 can be a pressure release valve. Alternatively, according to embodiments in which the drive system 138 utilizes pulleys and one or more drive belts, the overload release body can be a drive belt, such as, for example, a V-belt, and/or associated pulley that is/are configured for the drive belt to slip or otherwise be thrown off of the mating pulley, and/or break due to excessive heat at certain torque levels in a manner that can isolate components of the drive system 138 from exposure to excessive torques.

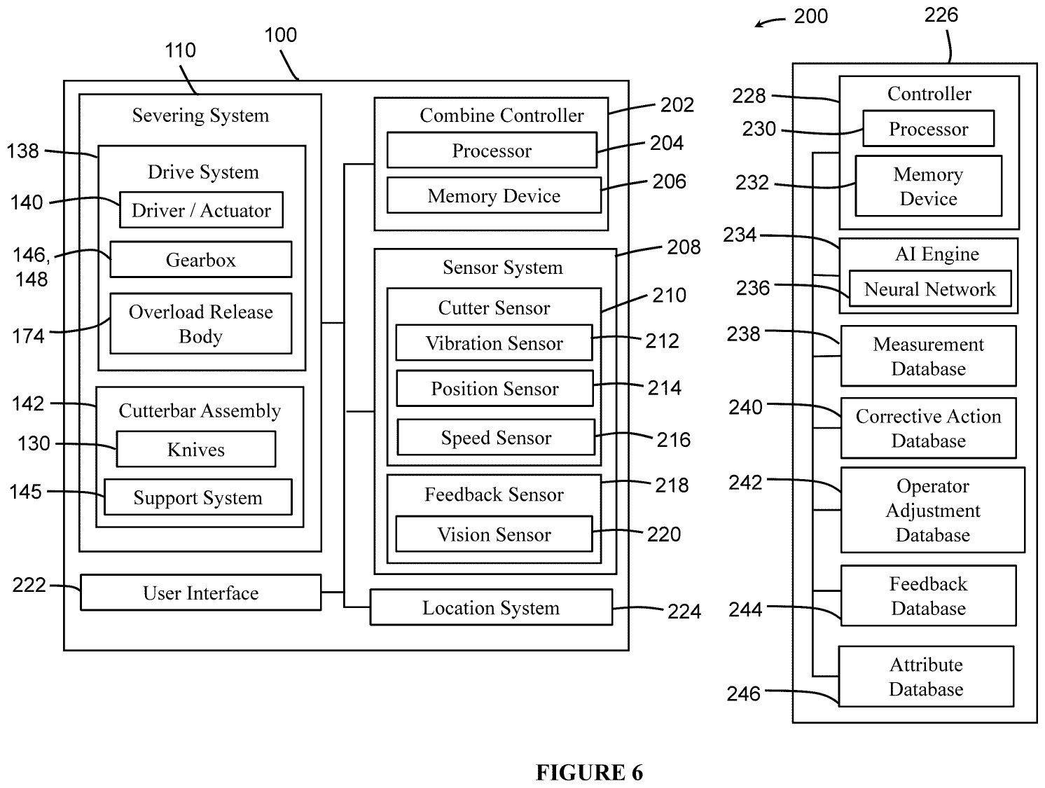

FIG. 6 illustrates a simplified block diagram of an exemplary cutting performance control system 200 for controlling the cutting performance of at least the severing system 110. As shown, at least a portion of the cutting performance control system 200 can be positioned at the agricultural machine 100. Additionally, as illustrated, the cutting performance control system 200 can include the severing system 110 that can include, for example, the drive system 138 and the cutterbar assembly 142, as well as associated components, as previously discussed. The cutting performance control system 200 can also include a controller(s) 202 having one or more processors 204 and one or more memory devices 206. The processor(s) 204 can be configured to follow instructions, including control instructions, contained with, or are part of, one or more of the memory devices 206, including, for example, a non-transitory machine-readable medium.

The processors 204 can be embodied as any type of processor or other compute circuit capable of performing various tasks. In some embodiments, each processor 204 can be embodied as a single or multi-core processor, a microcontroller, or other processing or controlling circuit. Additionally, in some embodiments, each processor 204 can be embodied as, include, or be coupled to an FPGA, an application specific integrated circuit (ASIC), reconfigurable hardware or hardware circuitry, or other specialized hardware to facilitate performance of the functions described herein. In some embodiments still, each processor 204 can be embodied as a high-power processor, an accelerator co-processor, an FPGA, or a storage controller.

Each memory device 206 can be embodied as any type of volatile (e.g., dynamic random-access memory (DRAM), etc.) or non-volatile memory capable of storing data therein. Volatile memory can be embodied as a storage medium that requires power to maintain the state of data stored by the medium. Non-limiting examples of volatile memory can include various types of random-access memory (RAM), such as dynamic random-access memory (DRAM) or static random-access memory (SRAM). In some embodiments, each memory device 206 can be embodied as a block addressable memory, such as those based on NAnd/or NOR technologies. Each memory device 206 can also include future generation nonvolatile devices or other byte addressable write-in-place nonvolatile memory devices. Additionally, in some embodiments, each memory device 206 can be embodied, or otherwise include, a memory device that uses chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. Each memory device 206 can refer to the device itself or to a packaged memory product. In some embodiments still, 3D crosspoint memory can comprise a transistor-less stackable cross point architecture in which memory cells sit at the intersection of word lines and bit lines and are individually addressable and in which bit storage is based on a change in bulk resistance. In some embodiments yet still, all or a portion of each memory device 206 can be integrated into the processor(s) 204. Regardless, each memory device 206 can store various software and data used during operation such as task request data, kernel map data, telemetry data, applications, programs, libraries, and drivers. Thus, the memory devices 206 can include information, including, but not limited to, algorithms, predetermined thresholds, pretrained models, and look-up tables, among other information, that can used by the processor 204, to identify the occurrence of one or more below discussed trigger conditions in connection with the performance of the severing system 110, as discussed below.

The cutting quality control system 200 can further include a sensor system 208 that can include at least a cutter sensor 210 that can sense information at, or around, the cutterbar assembly 142 that can correspond to a performance of the cutterbar 128 and/or a at least a portion of the knives 130 that are positioned about the cutterbar 128. For example, according to certain embodiments, the cutter sensor 210 can be one or more vibration sensors and/or accelerometers 212 that can detect vibrations or noise at or around the knives 130 or the support system 145, among other locations about the cutterbar 128. For example, in at least certain instances, the header 102 can encounter crop having certain crop attributes, such as, for example, green material crop, among other attributes. The change in crop attributes can increase the difficultly of the knives 130 with respect to cleanly cutting through crop, and instead may result in a slowing of the reciprocal movement of the knives 130 and/or the knives 130 tearing or ripping, instead of cutting, the crop. In such instances, a trigger condition, such as, for example, a hammering of the knives 130, can occur as the knives 130 may be experiencing difficulty in performing cuts through the crop. As a result, a level of vibration or other noise at, and around, the knives 130, among other portions of the cutterbar assembly 142, can increase. Accordingly, the vibration sensor 212 can be positioned to detect such vibrations, including changes in such vibrations, as cutting performance changes at least in connection with the controller 202 identifying a presence of a trigger condition at the severing system 110, including at the cutterbar assembly 142.

Additionally, or alternatively, the cutter sensor 210 can include a position sensor 214 that can provide an indication of a position, including a relative position, of one or more components of the cutterbar assembly 142 including, for example, a position of one or more knife sections 131. Such information provided by the position sensor 214 can indicate whether reciprocal movement of the knives 130 is being limited or has stopped, such as, for example, by a presence of trigger condition at the severing system 110 involving a blockage formed of crop or non-crop material and/or a slip or stall in the drive system 138, among other types of trigger conditions.

The cutter sensor 210 can also include a speed sensor(s) 216 that can detect a speed of reciprocal movement of one or more components of the cutterbar assembly 142, including, for example, one or more knives 130 or knife sections 131. For example, during certain operations in which the cutting performance of the cutterbar assembly 142 is generally considered to be normal or satisfactory, the knives 130 can be displaced in a reciprocal direction within an anticipated range of speed, as may be detected by the speed sensor 216. However, in certain situations a trigger condition can occur that changes the speed, if not stops the movement, of at least the knives 130. For example, the speed at which the knives 130 move can be adversely impacted by a trigger condition relating to, for example, a change in a crop attribute(s) (e.g., green crop material), a presence of a crop or non-crop material blockage in the cutterbar assembly 142, or a slip or stall in the drive system 138, among other trigger conditions. Such changes in the speed of the knives 130, or a stoppage in the reciprocal movement of the knives 130, can be detected using information obtained by the speed sensor 216.

As discussed below, information provided by the sensor system 208 regarding the operation of the severing system 110, including portions thereof, in connection with cutting crop in a field can be evaluated by an onboard controller(s) 202 and/or an offboard controller(s) 228, including via use of an associated processor(s) 204, 230 and/or via use of a neural network 236. Moreover, the controller(s) 202, 232 and/or one or more machine learning models of the neural network 236 can be used to identify a presence of a trigger condition that may relate to a performance issue with respect to the operation of the severing system 110, including, for example, a slip or stall by the drive system 138 and/or a degradation in the cut quality of the cutterbar assembly 142. Additionally, or alternatively, the machine learning model of the neural network 236 can be configured to at least identify one or more remedial or corrective actions with respect to at least the header 102 and/or the severing system 110 to address the identified trigger condition and/or to improve the cut quality being attained by the severing system 110.

To the extent one or more corrective actions provided by the machine learning models of the neural network 236 is/are implemented in the operation of at least the header 102 and/or the severing system 110, the system 200 can further include one or more feedback sensors 218 that can, in addition to, or in lieu of, information provided by the cutter sensor 210 that is obtained after the corrective action(s) is/are implemented, be used to evaluate the impact the corrective action(s) had on the performance of the severing system 110. As discussed below, such an evaluation can include determining whether the implemented corrective actions should be adjusted, supplemented with other corrective actions, or replaced. Additionally, as discussed below, the feedback information provided by the feedback sensors 218 can be utilized in the training, and/or retraining, of one or more of the machine learning models of the neural network 236 that may be utilized to identify the above-mentioned corrective action(s).

A variety of different types of sensors, and combinations of sensors, can be utilized for the feedback sensor(s) 218. For example, according to certain embodiments, the feedback sensor 218 can include a vision sensor 220, such as, for example, a camera that can capture a captured information, such as, for example, one or more photographs and/or videos, including still photographs and video frames or segments, among other types of captured information, that can be part of an optical recognition system and/or optical recognition features of the controller 202, 228. Examples of such vision sensors 220 can include, but is not limited to, stereo depth cameras, stereo sensors, RGBD (red, green, blue, depth) cameras, three-dimensional sensors, LIDAR, radar, and three-dimensional cameras, as well as combinations thereof, among other types of vision sensors.

According to certain embodiments, the feedback sensor 218 is positioned to obtain captured information from the portion of the crop, including a representation of at least some crop stubble remaining in the field after the crop has been cut by knives 130. Such captured information can include at least a representation of at least the portion of the crop stubble at or around the location at which the knives 130 cut the portion of the crop material being collected by the agricultural machine 100 from the stubble. Information obtained at such a portion of the stubble can provide an indication, including, for example, via analysis of the captured information by at least one controller(s) 202, 228, of the quality of the cut performed by the knives 130 and/or the cutterbar assembly 142. For example, such information derived by the controller 202, 228 from the stubble represented in the captured information can be used to determine whether the knives 130 cut through the crop cleanly, or in a manner in which the separated crop material was at least partially pulled, torn, or ripped from the portion of the crop that remained in the field as the stubble. Additionally, the captured information provided by the feedback sensor 218 can indicate at least some of the crop was not cut, including missed. Such captured information obtained by feedback sensor 218 indicating crop was not cut can be used by the controller 202, 228 to determine, for example, an occurrence of an interference with the operation of the cutterbar assembly 142, including, for example, with respect to the speed of reciprocal movement of the knives 130, that has resulted in crop being pushed or sliding under the cutterbar 128 without being cut. Further, such feedback information regarding the cut quality, and the associated corrective action(s), among other identified settings or attributes, can be evaluated in connection with the training of the machine learning model(s) of the neural network 236. Moreover, with respect to adjustments made in the operation of severing system in response to detection of a trigger condition, the information provided by the feedback sensor 218 can be used to evaluate at least the impact the adjustment caused by implementation of one or more particular corrective actions had on the operation of the severing system, 110, including with respect to cut quality.

The cutting performance control system 200 can also include a user interface 222 that an operator can use to interact with at least the controller 202. The user interface 222, which may be located at the agricultural machine 100, such as, for example, within an operator cab of the agricultural machine 100, and/or at a location remote from the agricultural machine 100, can include one or more input/output (I/O) devices, such as, for example, a steering wheel, joystick, button, keyboard, mouse, touch screen, display, microphone, and speaker, among other I/O devices. The user interface 222 can be utilize by the operator to input a variety of information to the controller 202, including, but not limited to, information regarding operator preferences with respect to the operation of the agricultural machine 100 and/or severing system 110, as well as operator preferences in terms of the aggressiveness the header 102 and/or severing system 110 is to operate when harvesting crop material. Additionally, the user interface 222 can be utilized to communicate information to the operator, including, for example, information regarding suggested corrective actions in response to a detection of a trigger condition(s) that can be determined using at least the machine learning model of the neural network 236, and/or communicate information obtained from the sensor system 208.

The agricultural machine 100 can also include, or be coupled to, a location system 224, such as, for example, a global positioning system (GPS). Information provided by the location system 222 can indicate a location of the agricultural machine 100, including, but not limited to, any or all of a longitudinal location, latitudinal location, and elevation of the agricultural machine 100. Further, information provided by the location system 222 can also be used to determine a direction of travel, heading, or compass bearing of the agricultural machine 100, among other information. Information provided by the location system 222 can further provide information regarding the location of the agricultural machine 100 relative to one or more field boundaries, including, but not limited to, boundaries between crop and non-crop areas. Additionally, information provided by the location system 222 can also be used in connection with a mapping system to track portions of a field containing a crop that, during at least a current harvesting operation, has been harvested by the agricultural machine 100, and other portions of the field having crop that has not yet been harvested. Such information may therefore provide an indication of the amount, or extent, of crop remaining to be harvested by the agricultural machine 100, and can be represented in a variety of manners, including, for example, in terms of an area, size, length, estimated quantity, and/or estimated time until completion of the harvesting operation.

As also seen in FIG. 6, according to certain embodiments, the cutting quality control system 200 can include another system, such as, for example, a central system 226 that can be remote or separate from the agricultural machine 100. According to such an embodiment, the central system 226 can be configured to receive information obtained by the operation of the agricultural machine 110, including, for example, at least information obtained from the sensor system 208, including the feedback sensor(s) 218, and/or inputted via the user interface 222. Such information provided to the central system 226 can be used by an artificial intelligence (AI) engine 234 that can include the neural network 236, and, moreover, can be utilized to train the above-discussed machine learning model(s) of the neural network 236. Such offboard training of the neural network 236, and the associated models, including algorithms, can result in a development of a model(s) of the neural network 236, including algorithms, that can then be communicated to, and used at, the agricultural machine 100. The communicated model(s), as well as any refinements or changes to the model that the neural network 236 can develop over time, can be stored by the memory device 206, or otherwise accessible to the controller 202, including the processor 204, at the agricultural machine 100 such that at least an identification of one or more corrective actions in response to a detection of a trigger condition can occur at the agricultural machine 100. Thus, according to such embodiments, the agricultural machine 100 can be directly or indirectly communicatively coupled to the central system 226, including, for example, via a wired or wireless connection that may utilize a network. Alternatively, rather than having such machine learning by a neural network 236 occur offboard, according to other embodiments, such training by the neural network 236 can occur onboard the agricultural machine 100.

The controller 228, as well as the associated at least one processor 230 and at least one memory device 232 of the central system 226 can have a configuration similar to that discussed above with respect to the controller 202, processor(s) 204, and memory device(s) 206 of the agricultural machine 100. According to certain embodiments, one or more of the memory devices 206, 232 can contain, or have access to, information indicative of predetermined ranges or values for sensed information obtained by one or more sensors 210, 212, 214, 216 of the sensor system 208 during periods of operation in which a trigger condition is not present. Moreover, such predetermined ranges can correspond to ranges or levels that are anticipated to be detected by the sensors 210, 212, 214, 216 of the sensor system 208 during general normal operation of the severing system 110, or portions thereof.

The system 200 can include one or more, including a plurality, of databases 238, 240, 242, 244, 246 that can retain historical information, including actual historical data and/or synthetic historical data, that can be utilized in connection with the neural network 236 developing one or more of the machine learnable models. With respect to the offboard embodiment shown in FIG. 6, such databases 238, 240, 242, 244, 246 can be located at, or otherwise accessible by, the neural network 236 of the central system 226. However, such databases 238, 240, 242, 244, 246 can be located at a variety of other locations, including with respect to onboard embodiments. Additionally, while FIG. 6 provides certain examples of databases 238, 240, 242, 244, 246, the types of databases as well as the type of information available from such databases can vary, and can be different, or in additional to, the databases 238, 240, 242, 244, 246 that shown in FIG. 6 and that are discussed below. Further, while some databases 238, 240, 242, 244, 246 are shown individually in FIG. 6, according to other embodiments one or more of the databases 238, 240, 242, 244, 246, including the associated information, can be combined with one or more other databases 238, 240, 242, 244, 246.

As illustrated, the system 200 can include a measurement database 238 which can contain historical measurement information regarding prior information provided by the sensor system 208. According to certain environments, the historical measurement information can be identified as corresponding to a particular type of trigger condition, including, for example, a trigger condition associated with: a slip or stall of the drive system 138; a blockage interfering with, if not prohibiting, the reciprocal movement of the knives 130; a deterioration in the cutting performance of the cutterbar assembly 142, including, for example, a degradation in performance associated with any breakage or dulling of one or more of the knives 130; and/or reduction in the performance of the severing system 110, including, for example, a decrease in the cut quality by the cutterbar assembly 142, attributed to a change in one or more of crop attributes, field attributes, and/or machine attributes, among other circumstances that can lead to an occurrence of a trigger condition(s). For example, information provided by the measurement database 238 can include historical measurement information regarding vibrations levels detected by the vibration sensor 212 during periods of operation of the cutterbar assembly 142 that are considered to be associated with normal or anticipated operation of the cutterbar assembly 142. Additionally, or alternatively, the historical measurement information can also include information regarding vibration levels that are considered to be outside of normal levels, including, for example, levels that historically have been determined to be associated with a hammering of the knives 130, among other information.

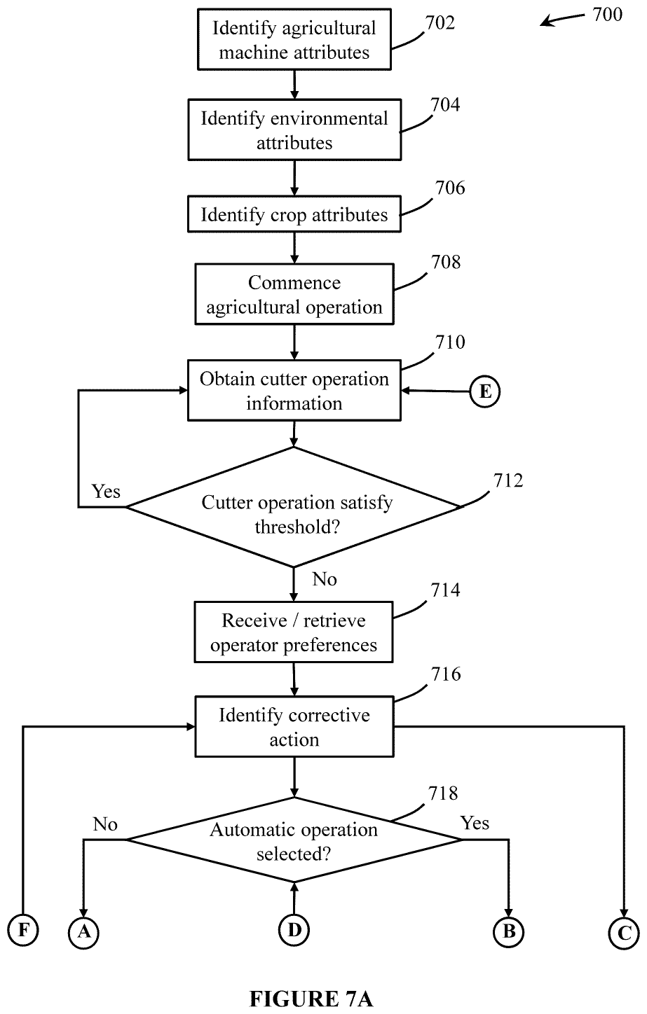

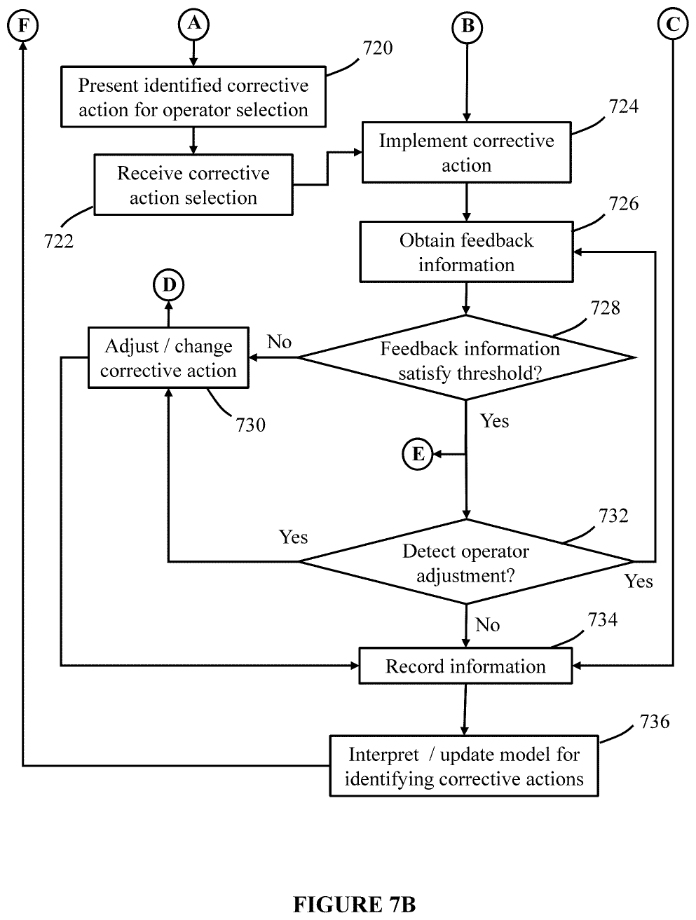

The system 200 can also include an attribute database 246 that can include historical information regarding crop, environmental, and/or agricultural machine 100 attributes at the time the corresponding measurement data, as now stored by the measurement database 238, was being obtained. For example, according to certain embodiments, the attribute database 246 can include information pertaining to characteristics the particular crop being harvested at the time the corresponding measurement data was obtained, including, for example, the type of crop material being harvested, crop height, crop spacing, crop moisture content, and/or crop health, among other crop related information. Additional types of historical crop attributes that can be stored by the attribute database 246 can include crop attributes that are at least similar to those discussed below with respect to at least block 706 of the method 700 shown in FIG. 7.

The attribute database 246 can further include historical environmental attribute information that can indicate characteristics of the ambient environment during the time the corresponding historical measurement information was being obtained. For example, such historical environmental attribute information can include, for example, information regarding soil temperature, ambient temperature, humidity, precipitation, and/or soil moisture content, among other environmental information. Additional types of historical environmental attributes that can be stored by the attribute database 246 can include environmental attributes similar to those discussed below with respect to at least block 704 of the method 700 shown in FIG. 7.

Additionally, the attribute database 246 can also include information regarding the agricultural machine 100, including, for example, the size and configuration of the agricultural machine 100. Attributes such as header subsystem speeds and positions, machine travel speed, and/or header position at the time the corresponding historical measurement information may be obtained. Such machine attribute information can also correspond to information regarding the different systems, including, for example, severing system 110 and sensor system 208 used by the agricultural machine 100. For example, information regarding the severing system 110 can indicate the type of drive system 138 utilized by the severing system 110, including, for example, the type of driver(s) 140 and/or overload release body 174 utilized by the drive system 138. Such machine attribute information can also include information regarding the type and position of sensors 212, 214, 216 utilized by the sensor system 208 in obtaining the corresponding historical measurement information, among other information. Additional types of historical machine attributes that can be stored by the attribute database 246 can include machine attributes that are at least similar to those discussed below with respect to at least block 702 of the method 700 shown in FIG. 7.

The system 200 can also include a corrective action database 240 that can include historical information regarding prior corrective actions implemented by the system 200, either automatically, semi-automatically, or manually. Such historical information regarding corrective actions can indicate a corresponding trigger condition that the implemented corrective action attempted to rectify or otherwise compensate for at least with respect to the performance of the severing system 110. Such historical corrective action information thus, can, for example, be linked to corresponding historical measurement information of the measurement database 238, as provided by the measurement database 238, so as to provide an indication of prior corrective actions taken with respect to trigger conditions that had certain characteristics. Additionally, or alternatively, such prior corrective actions can also be linked to one or more of the associated crop, environmental, and/or machine attributes, as can be identified by the attribute database 146, at the time the corrective action(s) was/were implemented.

The historical information provided by the corrective action database 240, as well as information provided by the measurement and attribute databases 142, 146 can also be correlated to corresponding historical feedback information that may be stored by a feedback database 244. Such historical feedback information of the feedback database 244 can be provided, for example, via the feedback sensor 218, and correspond to particular prior corrective actions, as may be identified by the corrective action database 240. Thus, for example, historical information regarding the outcome or effectiveness of adjustments made to at least the severing system 110 in response to prior implementations of particular corrective actions can be provided by the feedback database 244. Additionally, or alternatively, the corrective action database 240 can also be a knowledge based corrective action database that can exist, or be established, at least prior to any associations or learnings by the neural network 236. For example, according to certain embodiments, the corrective action database 240 can, at least initially, be a populated list of corrective actions associated with certain conditions or issues that may be identified, for example, by the type of information provided by the sensor system 208. Thus, the corrective action database 240 can, at least initially, be based on populated data, including either or both actual or synthetic data, and can adapt over time as additional information is collected by the system 200.

Thus, historical trigger conditions identified by prior measurements from the sensor system 208, the corrective action(s) implemented in response to the detected trigger condition(s), the resulting changes in the performance of the severing system 110, including with respect to cut quality, and various attributes that could have impacted the trigger condition and the effectiveness of the implemented corrective action(s) can be generally maintained by the measurement, corrective action, feedback, and attribute databases 238, 240, 244, 246. However, as previously mentioned, rather than being separate databases 238, 240, 244, 246 according to certain embodiments, one, if not all, of the databases 238, 240, 244, 246 can be combined with at least another one of the databases 238, 240, 244, 246.

The system 200 can further include an operator adjustment database 242 that can indicate adjustments made by an operator in response to the detected trigger condition(s). According to certain embodiments, the operator adjustment database 242 can provide an indication of which, if any, corrective actions proposed by the system 200, including, as a result of the determination of one or more machine learning models of the neural network 236, an operator implemented or rejected. Additionally, the operator adjustment database 242 can provide an indication of whether the operator implemented, in response to a detected trigger condition(s), other corrective measures that were different than the corrective action(s) proposed by the machine learning model of the neural network 236. Additionally, or alternatively, the operator adjustment database 242 can provide an indication of an adjustment that the operator made to a corrective action proposed by the machine learning models of the neural network 236.

The information provided by the databases 238, 240, 242, 244, 246, among other historical information, can be utilized by the neural network 236 to develop one or more of the above-discussed models, including algorithms, of the neural network 236. For example, according to certain embodiments, the neural network 236 can analyze historical information provided by the databases 238, 240, 242, 244, 246 to identify patterns that can assist with accurately identifying a trigger condition, including, for example, identifying a particular a type of trigger condition, and/or one or more corrective actions that can be implemented to overcome or compensate for the trigger condition. Additionally, the neural network 236 can utilize information provided by the operator adjustment database 242 and/or the feedback database 244 in a manner that can assist in at least improving which corrective actions being suggested by the system 200. Moreover, the neural network 236 may employ a feedback loop incorporating at least information from the operator adjustment database 242 and/or the feedback database 244 to enable the continuous refinement of the corrective actions suggested by the system 200, ensuring that the responses evolve in alignment with operator behaviors and real-world performance feedback. Additionally, the neural network 236 can leverage pattern recognition algorithms to classify types of trigger conditions identified from the historical datasets 238, 242, 244, 246. Such classification can aid in tailoring specific corrective actions to distinct categories of trigger conditions, thereby enhancing the precision and efficacy of the remedial measures implemented by the system 200. However, the type of trigger condition can be determined in a variety of other manners in addition to, or in lieu, of use of a machine learning model. For example, with respect to certain embodiments, the controller 202, 228 can be configured to identify one or more trigger event types using sensed or captured information, as provided by at least the sensor system 208, including the cutter sensor 210, regarding an operation(s) of one or more portions of the severing system 110 in view of embedded lookup tables, predetermined threshold/trigger values, and/or a pretrained model, among other manners of identifying a trigger condition type.

FIGS. 7A and 7B illustrate a simplified flow diagram of an exemplary method 700 of using the cutting performance control system 200 for controlling at least the cutting performance of the severing system 110. The method 700 is described below in the context of being carried out by the illustrated exemplary cutting performance control system 200. However, it should be appreciated that method 700 can likewise be carried out by any of the other described implementations, as well as variations thereof. Further, the method 700 corresponds to, or is otherwise associated with, performance of the blocks described below in the illustrative sequence of FIG. 7. It should be appreciated, however, that the method 700 can be performed in one or more sequences different from the illustrative sequence. Additionally, one or more of the blocks mentioned below may not be performed, and the method 700 can include steps or processes other than those discussed below.

At blocks 702, 704, 706 one or more attributes of the agricultural machine 100, environmental attributes, and crop attributes, respectively, can be identified, including identified to the controller 202, 228 and/or stored by at least the memory device 206, 232, or other portion of the system 200. As discussed below, such attribute information can be used by one or more of the deep learning models of, or developed by, the neural network 236 to identify the type of trigger condition and/or one or more corrective actions in response to a detection of a trigger condition.

The attributes of the agricultural machine 100, also referred to herein as machine attributes, identified at block 702 can be identified in a variety of different manners. For example, according to certain embodiments, the machine attributes can be attributes that are stored by the memory device 206, 232 and can be retrievable at least upon activation of the agricultural machine 100. Additionally, or alternatively, the machine attributes can be inputted by an operator of the agricultural machine 100, including, for example, via use of the user interface 222. Further, at least certain attributes pertaining to adjustable characteristics of the agricultural machine 100 and/or associated components, including positions (e.g., height, fore/aft), speeds, and/or orientations (e.g., tilt), activation/deactivation, and/or operational modes can be identified by information detected or obtained by one or more sensors of the agricultural machine 100.

A variety of types of machine attributes can be identified at block 702, including, for example, machine attributes similar to those discussed above with respect the attribute database 246. Moreover, the machine attributes identified at block 702 can correspond to attributes that can impact or influence measurements obtained by these sensors system 208 regarding at least the performance of the severing system 110.

For example, according to certain embodiments, the machine attributes identified at block 702 can include physical attributes, including dimensions, of the agricultural machine 100. For example, the identified machine attributes can provide an identification of the header 102 type, such as, for example, a size, length, and/or weight of the header 102. Such machine attributes can also include information regarding the drive system 138, including the type of mechanical, hydraulic, or pneumatic drive system used, and the number of drivers 140, among other information regarding the drive system 138. The machine attributes identified at block 702 can further include information regarding the cutterbar assembly 142, including, but not limited to, information regarding whether the knives 130 are double blade or single blade knives, and/or type, configuration, or age (e.g., hours or acres of usage) of the knives 130, among other information.

The machine attributes can further include various information regarding current operating conditions or settings of the agricultural machine 100, including, for example, information regarding: a header height; an orientation of the header 102 (e.g., lateral tilt, fore/aft tilt. etc.); a speed setpoint in terms of a travel speed for the agricultural machine 100; a float pressure with respect to the header 102, including, for example, with respect to the previously mentioned float arms; a fore/aft position of the cutterbar 128; a heading or direction of travel of the agricultural machine 100 (as may be identified using information from the location system 222); and, a current operational status or mode of the agricultural machine 100, including, for example, with respect to whether the machine is enabled or disabled as well as with respect to engaged and disengaged positions of the reel 206, among other operational modes. The machine attributes can further include settings inputted by the operator, including, for example, via use of the user interface 222, such as, for example, with respect to particular operational targets, sensitivities, and offsets, among other operator selected settings.

The environmental attributes identified at block 704 can be attributes that can be attributes external to the agricultural machine 100 that can interfere with the performance of at least the severing system 110. Accordingly, the environmental attributes can be obtained in a variety of manners, including using sensor that may or may not be part of the agricultural machine 110, be provided by other agricultural machines or equipment, including drones, among others, and/or retrieved from third party sources, including governmental and weather agencies, as well as various combinations thereof, among other sources.

Such attributes can include information regarding a position or elevation of the agricultural machine 100, including, for example, a latitudinal and longitudinal position of the agricultural machine 100 and/or and elevation of the agricultural machine 100, as may be determined, for example, using information provided by the location system 222. The environmental attributes can also include information regarding the terrain upon which the agricultural machine is located 100 or traveling, including, for example, information regarding the slope, pitch, and/or roll of the terrain, as well as a variability of the terrain, including with respect to changes or rates of change in the profile(s) of the terrain. Such environmental attributes can also relate to characteristics of the soil from which the agricultural machine 100 is harvesting crop and/or traveling, including, for example, with respect to moisture content, type, firmness, shear strength, and adhesion characteristics, among other attributes of the soil. Such environmental attributes can also include features regarding the intensity of the sunlight, if any, the corresponding light angle being provided by such sunlight, and/or cloud coverage. Other environmental attributes can relate to a current heat load from the sun that the agricultural machine 100 or crop may be experiencing. Other environmental attributes can relate to ambient conditions, including, for example, ambient temperature, dew point, humidity, evapotranspiration, odor, and/or dust coverage, among other ambient conditions. The environmental attributes can also include information regarding precipitation, including levels of accumulated precipitation and precipitation states, including, for example, whether the agricultural operation being performed by the agricultural machine 110 is occurring during at least periods in which rain is falling, as well as the amount of accumulated rain fall. Further, environmental features can include information regarding wind conditions, such as, for example, wind direction, including wind direction relative to the heading of the agricultural machine 100, and wind intensity, such as wind speed. Environmental attributes can also include information regarding attributes of the field in which the agricultural machine 100 is performing the agricultural operation, including, for example, an identification of fixed and/or dynamic obstacles, field conditions, locations at which crop has already been harvested, and locations of crop that is to be harvested, among other field features.

The crop attributes identified at block 706 can include attributes that can be identified by one or more sensors, including, for example, sensors of the agricultural machine 100, inputted to the system 200 by the operator, including, for example, by use of the user interface 222, and/or retrieved or communicated to the system 200, including from other agricultural machines or equipment. The identified crop attributes can include information regarding the crops that are to be harvested, including, for example, a crop height, state (e.g., whether crop is leaning, lodged, standing, or down), health status, population, type, biomass yield, mechanics, and/or damage (e.g., fungus or pest related damage). Additionally, the identified crop attributes can be at least partially dependent on the type of crop. For example, with respect to certain products, the crop attributes can include a size and moisture content of a plant stem or stalk of the crop, a leaf moisture content, a height and/or size of a wheat head or bean pod, and features relating to an attachment of the head or pod to the plant stem, among other features. Crop attributes can also relate to the presence of other plants in the area in which the crop is being harvested, including, for example, the presence, intensity, and/or type of weed(s) that may be intermingled with the crop. Crop attributes can also include an indication of a harvest state of the crop column including, for example, whether the crop has, or has not yet, been harvested.

At block 708, the agricultural operation that is to be performed by the agricultural machine 100 can commence. Thus, for example, at block 708, with respect to agricultural machines 100 that are harvesters, the agricultural machine 100 can commence with harvesting crop from a field at block 708.

As the agricultural machine 100 is performing the agricultural operation, the cutter sensor 210 of the sensor system 208 can be used to collect information used to monitor the performance of the severing system 110, as previously discussed. Moreover, the information provided by at least the cutter sensor 210 can be provided by the controller 202, 228 in connection with at least attempting to determine if a trigger condition is, or has, occurred. The controller 202, 228 can identify a presence of a trigger condition in a variety of manners. For example, as discussed above, the sensor system 208, including, for example, the cutter sensor 210, can measure a variety of different types of information at or around the cutterbar assembly 142 at least during operation of the severing system 110. The memory device 206, 232, among other portions of the system 200, can store predetermined thresholds, including ranges, anticipated to be measured or otherwise provided by at least the cutter sensor 210 when the severing system 100 is operating at what may be generally considered normal or satisfactory levels. The predetermined thresholds can be determined in a variety of manners, including, for example, based on one or more lookup tables, algorithms, models, operator inputs, and/or default settings, as well as various combinations thereof, among other manners of identifying, selecting, or setting one or more predetermined threshold(s). Additionally, the manner in which at least some predetermined thresholds are determined may, or may not, be similar to the manner other predetermined thresholds are determined. Further, in at least certain situations, a determination that information provided by the cutter sensor 208 does not satisfy the corresponding predetermined threshold can be an indication that the cut quality being attained by operation of the severing system 110, including at least the cutterbar assembly 142, may not be satisfactory. For example, a failure to satisfy such a predetermined threshold can provide an indication that the knives 130 are experiencing difficulty in cutting the crop material, including missing, tearing or ripping, rather than cleanly cutting, the crop.

Thus, the information, including measurements, obtained via use of the one or more cutter sensors 210 can be evaluated, including compared, relative to a corresponding predetermined threshold by the controller 202, 228 to identify whether the measured information does, or does not, satisfy the corresponding predetermined threshold. Moreover, the controller 202, 228 can compare the measured information provided by the one or more cutter sensors 210 to the associated predetermined threshold to identify whether an anomaly is, or is not, present in the information provided by the cutter sensor 210. Instances in which such an anomaly is present in the information provided by the cutter sensor 210, as identified by controller 202, 228 determining at least a portion of the information provided by the cutter sensor 210 does not satisfy the predetermined threshold, can indicate a presence of a trigger condition.

For example, a speed sensor(s) 216 can provide information regarding the speed at which the knives 130, or other portion of the cutterbar 128, is/are, or have been, reciprocally moving. The controller 202, 228 can use such speed information to determine whether such speeds satisfy a predetermined speed level. Satisfaction of such a predetermined speed level can be at least one indication that the severing system 110, including the drive system 138 and/or cutterbar assembly 142, are operating within normal ranges or as anticipated. However, in some situations, one or more crop attributes, environment attributes, and/or machine attributes, including changes in such attributes, can cause the knives 130 or other portion of the cutterbar 128 to slow down to levels that, when evaluated by the controller 202, 228 using information from the speed sensor(s) 216, does not satisfy the predetermined speed level. Such failure to satisfy the predetermined speed level can indicate a presence of a trigger condition in at least a portion of the severing system 110.

While the foregoing example is discussed with respect to information from the speed sensor 216, similar predetermined thresholds can also apply to other cutter sensors 210. For example, with respect to the position sensor 214, the position sensor can be utilized to identify whether the knives 130 or other portion of the cutterbar assembly 142 are either or both reaching and returning to certain preidentified positions. Moreover, the position sensor 214 can indicate whether the knives 130 or other portion of the cutterbar assembly 142 have, or are obtaining, a full range of expected motion or displacement during the associated the reciprocal movement. Accordingly, the corresponding predetermined threshold can be a distance threshold from a particular location, or an anticipated distance of travel during the reciprocal movement of the knives 130 or other portion of the cutterbar assembly 142. A determination by the controller 202, 228 that at least a portion of the information provided by the position sensor 214 does not satisfy the corresponding predetermined threshold can provide an indication of a trigger condition in at least the severing system 110 that may be related to a restriction or stoppage of movement of the knives 130 or other portion of the cutterbar assembly 142. With respect to the vibration sensor 212, the predetermined threshold may correspond to anticipated vibration or noise levels, which, if a corresponding predetermined threshold for vibrations or noise is not satisfied, can also indicate a presence of a trigger condition.

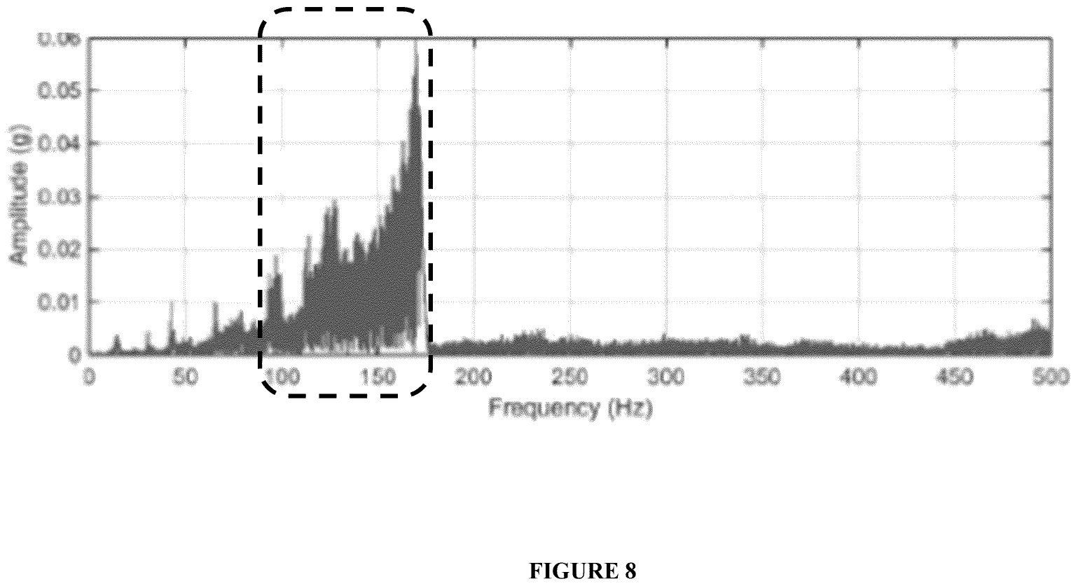

The information, including signals, provided by the cutter sensor(s) 210 can also be transformed, such as, for example, via signal or waveform processing such as a frequency spectrum analysis, including, but not limited to, via the use of a Fast Fourier Transform (FFT) algorithm, among others. Such a frequency spectrum analysis can be utilized to at least filter signal noise and/or to transform the associated signal into a form that may improve the ease in evaluating whether the corresponding information satisfies the associated predetermined threshold. For example, at least certain information provided by the cutter sensor(s) 210, including, for example, vibration information from the vibration sensor 212, may be in the time domain. The controller 202, 228 can be configured to transform such time domain information to another domain or spectrum, such as, for example, to a frequency domain or spectrum in at least an effort to filter the corresponding signal and/or improve the ease in identifying instances in which features of the measured information indicate the corresponding predetermined threshold has not been satisfied. For example, a Fast Fourier Transform (FFT) algorithm can be used to compute the Discrete Fourier Transform (DFT) so that the time domain information provided by the vibration sensor 212 is transformed into a manner that identifies a measured amplitude of the vibration, which in this example is an acceleration amplitude (g), over different frequencies, as measured in Hertz (Hz), rather than time, as demonstrated by FIG. 8.

In the example shown in FIG. 8, a predetermined threshold for measured acceleration amplitude can be set to be acceleration amplitudes that are less than, or do not exceed, 0.01 g. Thus, in this example, acceleration amplitudes that are below 0.01 g can be considered to indicate normal or acceptable operation of the severing system 110 and/or the cutterbar assembly 142. Therefore, in FIG. 8, the acceleration amplitudes depicted from at least at the about 160 Hertz to the 500 Hertz range can be determined by the controller 202, 228 to correspond to instances during which the severing system 110 and/or cutterbar assembly 142 is operating in a manner that may generally be considered normal or anticipated. However, in this example, as seen in FIG. 8, slightly before reaching 100 Hertz, the acceleration amplitude raises to about 0.015 g, which exceeds the exemplary predetermined threshold of 0.01 g, and continues to increase to about 0.06 g at around 175 Hertz. Such increases in the acceleration amplitude above the corresponding predetermined threshold can indicate the presence of a trigger condition in one or more portions of the severing system 110.

In addition to identifying whether a trigger condition is present, according to certain embodiments, such information from the cutter sensor 210, as well as at least the attribute information provided at one or more, if not all, of blocks 702, 704, 706, among other information, can be used to not only identify an occurrence of a trigger condition(s), but also to identify the type of trigger condition. For example, according to certain embodiments, the neural network 236 can be trained using historical information from the previously discussed databases 236, 238, 240, 242, 244, 246, among other information, to identify patterns that can be used to identify, including predict, a particular type of trigger condition associated with the detected trigger condition. Moreover, the model developed by the neural network can be utilized to identify a type or trigger condition based at least on the particular combination of identified crop, environmental, and/or machine attributes (from blocks 702, 704, and/or 706) in view of the characteristics of the measured information provided at block 710 by the cutter sensor(s) 210. Such patterns can be used to generate a confidence score or rating in terms of the likelihood the type of trigger condition identified by the neural network 236 is the actual type of trigger condition being experienced by the severing system 110. Further, the neural network 236 can also be configured to identify a variety of different types of trigger conditions, including, for example, trigger conditions associated with an activation of the overload release body 174 that ceases the transmission of power to at least certain components of the drive system 138, a stall in the operation of the drive system 138, a presence of a blockage interfering with the movement of the cutterbar assembly 142, and/or one or more particular crop, environmental, and/or machine attributes, including a change in such an attribute, that has adversely impacted the performance of the severing system 110.

For example, with respect to FIG. 8, as discussed above, the controller 202, 228 can identify, based on a predetermined threshold relating to the measured vibration not being satisfied, that a trigger condition has occurred slightly before 100 Hertz. Additionally, the neural network 236 can be trained to develop a model that can be used to identify, based at least on the vibration information provided by the vibration sensor 212, and in view of other identified attributes (e.g. crop, environmental, and/or machine attributes), the characteristics of the acceleration amplitude detected around just before 100 Hertz, and possibly for a period thereafter, that may indicate the type of trigger condition, For example, using at least the information provided at block 710, the model may, in this example, identify that the trigger condition occurring at slightly before 100 Hertz corresponds to a change in a crop attribute, and, more specifically, may indicate a change in terms of the cutterbar assembly 142 encountering green crop material. Additionally, as the acceleration amplitude continuous to increase to about 0.06 g, the model developed by the neural network 236 can be used to identify that the trigger condition has changed, or alternatively now also includes, a hammering of the knives 130. Such identification of one or more current trigger condition types can, optionally, assist in the subsequent identification of one or more associated corrective actions, as discussed below with respect to block 716.

In the event a trigger condition is not identified at block 712, the method 700 can return to block 710, wherein information from the one or more cutter sensor(s) 210 can continue to be collected and evaluated in connection with the associated predetermined threshold(s). If, however, the controller 202, 228 does identify a potential presence of a trigger condition at block 712, then the method 700 can proceed to block 714, wherein preferences from the operator can be retrieved, such as, for example, preferences stored by the memory device 206 or requested from the operator, such as, for example, by a signal communicated to the user interface 222. The operator preferences can, according to certain embodiments, correspond to a level or degree of aggressiveness in terms of potential corrective actions that may be suggested by the system 200, including, for example, by the controller 202, 228, to address be detected trigger condition. For example, with respect to corrective actions that may involve adjusting a speed of the reciprocal movement of the knives 130, some operators may have a preference for being more conservative than other operators in terms of the extent such speed is to be increased, and/or the speed at which the knives 130 can be displaced. Additionally, certain operators may be more tolerant to a presence of a trigger condition and at least certain situations, including, for example, with respect to at least certain types of detected trigger conditions or identified trigger condition types when certain predetermined conditions are satisfied. For example, according to certain embodiments, an operator can identify one or more types of trigger conditions at which the agricultural machine 100 can continue to operate without adjustments, or, alternatively, allow at an implementation of at least certain corrective actions, if a certain percentage or portion of the agricultural operation remains for completion, or has been completed, by the agricultural machine 100. Thus, for example, in such examples, despite a detection of a trigger condition, if the agricultural operation being performed by the agricultural machine 100 is near completion, such as, for example, a certain percentage of the field has crop material that has, or has not yet, been harvested, the operator may have a relatively aggressive preference to continue with the current operation and/or settings despite the detection of the trigger condition, or, alternatively, allow for an implementation of a relatively aggressive corrective action. However, other operators may be more conservative, and may instead have a preference to implement a corrective action regardless of what percentage of the associated agricultural operation has not been yet completed.

The operator preferences at block 714 can also correspond to whether the operator has selected automatic, semi-automatic, and/or manual implementation of one or more of the corrective actions that can be identified by at least the controller 202, 228 in response to a detected trigger condition. For example, with respect to automatic implementation, the controller 202, 228 may automatically implement one or more corrective actions identified by the neural network 236 to address a detected trigger condition. With respect to manual implementation, the controller 202, 228 can be configured to generate a signal to display one or more corrective actions 222 for selection by the operator by use of the user interface 222. According to such embodiments, the controller 202, 228 may await for receipt of a signal indicating a selection, or approval, by the operator of a corrective action(s) before that corrective action(s) is implemented. With respect to semi-automatic implementation, the operator preferences identified at block 714 can indicate at least certain types of trigger conditions and/or corrective actions that can be automatically implemented by the system 200, and/or identify certain types of trigger conditions and/or corrective actions that are to be manually implemented via one or more instructions from the operator, as communicated to the controller 202, 228 via the user interface 222. Additionally, or alternatively, semi-automatic implementations may involve at least a portion of the corrective action being implemented automatically by the system 200, and other portions of the corrective action being manually implemented by the operator.

At block 718, the model developed by the neural network 236 can provide one or more suggested corrective actions for implementation in response to the detected trigger condition. As previously discussed, the corrective actions identified by the model can be based at least on the training of the neural network 236, including using historical information to identify patterns when a variety of combinations of crop, environmental, and/or machine attributes are identified and for certain corresponding measured information similar to that provided by the cutter sensor 210. Thus, using the model(s) developed by the neural network 236 can utilize at least the information provided by the cutter sensor 210 at block 710, the attributes identified at one or more of blocks 702, 704, 706, and the identified operator preferences from block 714 to output one or more suggested corrective actions for addressing, including remediating or compensating for, the detected trigger condition. Additionally, or alternatively, as previously discussed, the one or more corrective actions identified by the model can correspond to the type of trigger conditioned identified, if any, at block 712. Moreover, the corrective actions identified by the model may, based on the analysis performed by the neural network 236 and/or the controller 202, be derived based on an attempt to improve or optimize the crop cut quality in view of the current trigger condition and/or other attributes. Thus, for example, the corrective actions identified by the model may be based at least in part on analysis performed by the neural network 236 and/or the controller 202 of both historical and current information.

A variety of different types of corrective actions can be identified based on one or more characteristics of the detected trigger condition. For example, according to certain embodiments, the model(s) may identify a change in the speed of reciprocal movement of the knives 130 as a potential corrective action. Whether such a change in speed is to involve an increase or decrease in speed can, at least in part, be based on an operator preference, as identified at block 714. For example, as previously mentioned, certain operators may select more aggressive settings, in which case the model of the neural network 236 can suggest a remedial action that attempts to resolve a detected trigger condition by increasing at least a speed at which the knives 130 are displaced. Alternatively, operator preferences may indicate an operator has a preference for less aggressive, or more conservative, corrective actions, including with respect to incurring additional potential risks in terms of potential damage to one or more components of the severing system 110. In such instances, the corrective actions provided by the model of the neural network 236 can include, for example, slowing down the speed of at least the knives 130, if not stop the reciprocal movement of the knives 130.

According to certain embodiments, the preferences of the operator in terms of the aggressiveness of the corrective actions that may be implemented can vary based on other criteria, including, for example, a percentage or extent of the associated agricultural operation remaining to be completed, an estimated time until completion of the associated agricultural operation, a current time of day, the type of corrective action, the characteristics of the identified trigger condition, and/or historical information, among other criteria. For example, according to certain embodiments, an operator preference with respect to aggressiveness level of a corrective action can increase in terms of aggressiveness as the amount of crop remained to be harvested during a particular agricultural operation decreases. Thus, for example, an operator may be more willing to tolerate a presence of a trigger condition, or an implementation of a particular corrective action, as the agricultural operation comes closer to completion. Alternatively, other operators' preference with respect to aggressiveness level of a corrective action may decrease as the amount of crop remained to be harvested during a particular agricultural operation decreases in at least an attempt to complete the harvesting operation without a breakdown in the operation of the severing system 110 and/or the agricultural machine 100.

Another exemplary corrective action can involve adjusting a height of the header 102, including, for example, adjusting the header height to a different height and/or restoring the header height to a height at which the header 102 was previously positioned. For example, according to certain embodiments, the trigger condition can correspond to a change in a crop attribute, such as, for example, the header 102 engaging green crop material. In such situations in which the change in it crop attribute adversely impacts the performance of the severing system 110, the model of the neural network 236 can suggest a corrective action in the form of raising the header height. A variety of other corrective actions can include the positioning and/or orientation of one or more components of the header, including, for example, with respect to a fore/aft position, tilt, or yaw, as well as changes in operational speeds, including speeds outputted by the driver 140. Moreover, the corrective actions can include altering the speed, pressure, or angle of the cutterbar assembly 142 to optimize the quality of subsequent cuts based on the analysis performed by the neural network 236 and/or the controller 202. Other corrective actions can include a stoppage in the operation of the severing/system 110 and/or the agriculture machine 100 so as to provide time for an inspection of one or more components of the agriculture machine 100. Thus, the type of corrective actions suggested by the model of the neural network 236 can be tailored or customized based at least on the characteristics of the particular trigger condition identified at block 712, the type of trigger condition identified at block 712, and/or operator preferences, among other parameters.

Additionally, historical information may indicate a particular trigger condition has, in the past, arisen in a certain location within the field. For example, such a trigger condition can be attributed to a particular environmental attribute, including, for example, terrain profile, at the associated location within a field. In such situations, an occurrence of such a trigger condition can, from historical information, be anticipated. Thus, the training of the model of the neural network 236 can utilize such, or similar, historical information to predict an occurrence of the trigger condition, as well as to identify the effectiveness of any prior corrective actions, if any, that were implemented in response to the occurrence of the trigger condition. Such historical information can thus be utilized to train the model with respect to determining what, if any, corrective action is to be suggested and/or implemented upon the occurrence of such an anticipated trigger condition.

At block 718, the controller 202 can determine whether the operator preferences, as retrieved at block 714, indicate that corrective actions are to be automatically, semi-automatically, or manually implemented. Thus, for example, if the corrective actions are to be manually implemented, the method 700 can proceed to block 720, wherein the one or more suggested corrective actions can be communicated to the operator 720, and the operator can input a selection of a corrective action at block 722 that the controller 202 can implement at block 724. Alternatively, in response to the corrective actions communicated to the operator at block 720, the method 700 can proceed to block 724, wherein in the operator can manually input, via the user interface 222, one or more commands that can adjust one or more settings of one or more systems or components of the agricultural machine 100, including of the severing system 110, in a manner that may, may partially, or may not, correspond to the corrective actions communicated to the operator at block 720.

With respect to automatic implementations, as seen in FIG. 7, the method 700 can proceed to block 724, wherein the controller 202 can generate one or more signals to implement the one or more suggested corrective actions. With respect to semi-automatic implementations, depending on the operator preferences with respect to the type of trigger condition and/or type of corrective action being suggested, the method 700 can proceed to either block 720 or block 724, or a combination thereof.

At block 726, feedback information can be utilized to evaluate the impact the corrective action(s) implemented at block 724 have had with respect to the detected trigger condition, including, for example, with respect to resolving or compensating for the detected trigger condition. Such feedback information can include, for example, information indicating whether measurements obtained by the cutter sensor 210, satisfies the associated predetermined threshold, as determined by at least the controller 202.

Additionally, to at least the extent the trigger condition adversely impacted the cut quality being obtained by the severing system 110, including by the cutter assembly 142, such an evaluation at block 726 can include utilizing information provided by the feedback sensor 218, including, for example, the vision sensor 220. Moreover, the information provided by the vision sensor 220 can be used to determine, such as, for example, by the controller 202 and/or model of the neural network 236, whether be adjustment(s) implemented at block 724 has resulted in an improved cut quality. Thus, for example, the representation provided by the captured information obtained by the vision sensor 220 can provide enough information or detail to allow the controller 202 and/or model of the neural network 236 to determine the quality of the cut obtained by the cutterbar assembly 142. According to certain embodiments, the captured information obtained by the vision sensor 220 can include image data, depth data, or a combination thereof, which the controller 202 processes to evaluate the uniformity of the cut achieved by the cutterbar assembly 142. The depth data can, for example, offer information on the consistency of the cut depth along the cutterbar assembly 142. Additionally, or alternatively, the model of the neural network 236 can be trained to identify specific patterns or anomalies in the captured information that correlate to various quality metrics of the cut, such as smoothness, precision, and the occurrence of jagged edges. The training process for the model of the neural network 236 may therefore also involve using a dataset comprising images and depth data of cuts with known quality ratings.

According to certain embodiments, at block 728 the feedback information obtained at block 726 can be evaluated, including, for example, via use of the controller 202 and/or the model of the neural network 236, including evaluated by the controller 202 to determine if one or more predetermined feedback thresholds are satisfied. The predetermined feedback thresholds can, for example, be based on the quality of cut, also referred to as cut quality, as determined by an evaluation of the information obtained at block 728. The types of information used for the predetermined feedback threshold can include image data from the captured information, as provided by the vision sensor 220, indicating the cut quality, the consistency of the cut along the stubble, as may be indicated, for example, by the uniformity of the cut across the length of the stubble, the accuracy of the cut in terms of a height of the stubble, identification of specific patterns or anomalies in the captured information that correlate to cut quality metrics. Additionally, the cut quality can be based, at least in part, on comparing data from the captured information with historical data representing prior cuts indicative of normal operation of at least the severing system 110. Further, the neural network 236 can be trained to evaluate the cut quality in view of the presence of one or more crop and/or environmental attributes that were identified at least at blocks 704 and 706 that may influence the cut quality.

If the predetermined feedback threshold is determined by at least the controller 202 and/or model of the neural network 236 to not be satisfied at block 728, then at block 730 the corrective actions that were implemented at block 724 can be adjusted and/or supplemented with the implementation of other corrective actions. Additionally, or alternatively, at block 730, the previously implemented corrective actions can be undone, such as, for example, returning the associated components or systems of the severing system 110 to the settings being used by those components or systems prior to implementation of the corrective action at block 724. In such a situation, with at least those prior settings restored, other corrective actions can be identified using the model of the neural network 236, and the method can return to block 718. Additionally, or alternatively, one or more of the corrective actions previously identified at block 716 but not implemented at block 724 can again be identified and/or selected at block 730 for implementation. Again, as with the corrective actions discussed above with respect to block 716, the corrective actions identified at block 730 by the model of the neural network 236 can be at least partially based on operator preferences, and can include adjustments to at least the speed of reciprocal movement of the knives 130, an adjustment of a cutting or height angle for the cuts being made by the knives 130, or material feeding rate with respect to engagement of the knives 130 with crop in the field, among other corrective actions.

If the controller 202 and/or model of the neural network 236 determines at block 728 that the predetermined feedback threshold(s) are satisfied, the method 700 can return to block 710, wherein information obtained from the cutter center 210 can continue to be evaluated to the associated threshold, as discussed above.

At block 732, the controller 202, among other portions of the system 200, can determine whether the operator has adjusted any of the corrective actions that have been implemented at either block 724 or block 730. Such adjustments can, for example, be inputted by the operator via use of the user interface 222. The adjustments implemented by the operator can also be evaluated at block 728 using the predetermined feedback threshold in a manner similar to that discussed above.

The corrective actions that were implemented (e.g., block 724) and the corresponding results, including, for example, cutting quality, as detected using information provided by the feedback sensor 218 (block 726) and evaluated by the controller 202 and/or model of the neural network (block 728), as well as any supplemental corrective actions (block 730) and operator adjustments (block 734) can be recorded at block 734. The data recorded at block 734 can include, for example, the implemented corrective actions and their effectiveness with respect to the performance of at least the performance of the severing system 110, or portion thereof, in resolving the trigger condition and/or with respect to the cut quality obtained by the severing system 110 in view of the at least temporarily presence of the trigger condition.

The information recorded at block 734 can be interpreted at block 736 by the neural network 236 with respect to the impact the implemented corrective actions had on the performance of at least the severing system 110, or portions thereof. Thus, for example, the type of corrective action(s) implemented in view of the identified trigger condition(s), as well as the extent such a corrective action(s) had in adjusting or changing an operation of the severing system 110, or portions thereof, in view of the identified change, if any, on the performance of the severing system 110, as indicated by the feedback information, can be evaluated at block 736. Such an evaluation and interpretation of at least the information recorded at block 734 can be utilized by the neural network 236 in connection with training, or retraining, the neural network 236 at block 736 so as to improve the effectiveness of the corrective actions the model of the neural network 236 may identify in response to future trigger conditions.

According to certain embodiments, the data recorded at block 734 can, at block 736, be parameterized into various categories such as type of corrective action, time of implementation, changes in cutting quality parameters, and feedback loop duration. Such recorded data can be utilized to further train or retrain the neural network 236, thereby enhancing the predictive and corrective capabilities of the model of the neural network 236. For example, according to certain embodiments, the neural network 236 may incorporate an adaptive learning algorithm that utilizes the recorded data at block 734 to update its internal parameters. Such updated internal parameters can include, for example, tuning weights and biases in network layers that may be part of the training process to optimize performance of the model of the neural network 236.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A system for controlling a performance of a severing system of an agricultural machine for cutting a crop material, the system comprising:
a severing system having a cutterbar assembly having a plurality of knives configured for a reciprocal movement to cut the crop material;
a sensor system including a cutter sensor configured to obtain a first information regarding the performance of the severing system;
at least one processor; and
at least one memory device storing instructions that, when executed by the at least one processor, cause the system to:
compare the first information to a predetermined threshold to identify an occurrence of a trigger condition;
receive, in response to the occurrence of the trigger condition, one or more corrective actions, the one or more corrective action identified based on at least one or more characteristics of the trigger condition; and
generate a control signal to implement at least one corrective action of the one or more corrective actions.

2. The system of claim 1, wherein the one or more corrective actions are identified by use of a machine learning algorithm of a neural network based on at least one of a current crop attribute, a current environmental attribute, and a current machine attribute.

3. The system of claim 2, wherein the at least one memory device further includes instructions that, when executed by the at least one processor, cause the system to analyze, for continuous training of the neural network based on machine learning, a historical information that includes at least one of a historical crop attribute, a historical environmental attribute, and a historical machine attribute.

4. The system of claim 2, wherein the at least one memory device further includes instructions that, when executed by the at least one processor, cause the system to identify at least one operator preference, and wherein the one or more corrective actions identified by the neural network is further based at least on the at least one operator preference.

5. The system of claim 2, wherein the neural network is further configured to identify based on at least the one or more characteristics of the trigger condition a trigger condition type.

6. The system of claim 2, wherein the at least one memory device further includes instructions that, when executed by the at least one processor, cause the system to analyze, for continuous training of the neural network based on machine learning, historical data pertaining to identified trigger conditions and corresponding corrective actions.

7. The system of claim 1, wherein the cutter sensor comprises at least one of (1) a vibration sensor or an accelerometer positioned to detect a vibration or a noise at or around the plurality of knives; (2) a position sensor configured to detect a position of one or more knife; and (3) a speed sensor configured to detect a speed of the reciprocal movement.

8. The system of claim 1, further comprising a feedback sensor positioned to obtain a second information that includes a representation of a cut to at least a portion of the crop material by the cutterbar assembly, wherein the at least one memory device further includes instructions that, when executed by the at least one processor, cause the system to evaluate, after the at least one corrective action is implemented, the at least one corrective action based at least on a comparison of the second information with a predetermined feedback threshold.

9. The system of claim 8, wherein the at least one memory device further includes instructions that, when executed by the at least one processor, cause the system to analyze, for continuous training of a machine learning model of a neural network, an effectiveness of the at least one corrective action using at least the second information from the feedback sensor, and wherein the one or more corrective actions are identified by use of the machine learning algorithm of the neural network.

10. The system of claim 8, wherein the at least one memory device further includes instructions that, when executed by the at least one processor, cause the system to adjust the at least one corrective action in response to the second information not satisfying the predetermined feedback threshold.

11. The system of claim 10, wherein the adjustment of the at least one corrective action comprises a replacement of the at least one corrective action with another corrective action.

12. The system of claim 1, wherein the at least one memory device further includes instructions that, when executed by the at least one processor, cause the system to transform the first information from a time domain to another domain using a frequency spectrum analysis.

13. A method for controlling a performance of a severing system of an agricultural machine for cutting a crop material, the method comprising:
receiving a sensor data from a sensor system corresponding to the performance of the severing system;
comparing the received sensor data to a predetermined threshold to identify an occurrence of a trigger condition;
identifying, one or more corrective actions based on at least one or more characteristics of the trigger condition; and
issuing a control signal to implement at least one corrective action of the one or more corrective actions; and
evaluating the at least one corrective action based at least on a comparison of a feedback information sensed by a feedback sensor with a predetermined feedback threshold, the feedback information including a representation of a cut quality by the severing system while the at least one corrective action is implemented.

14. The method of claim 13, further comprising evaluating the at least one corrective action based at least on a comparison of a feedback information sensed by a feedback sensor with a predetermined feedback threshold, the feedback information including a representation of a cut quality by the severing system while the at least one corrective action is implemented.

15. The method of claim 14, further comprising capturing the feedback information using at least one vision sensor, and wherein the feedback information includes a representation of the cut quality at one or more pieces of crop stubble remaining in a field after the crop material is cut.

16. The method of claim 14, further comprising analyzing, for continuous training of a machine learning model of a neural network, an effectiveness of the at least one corrective action using the feedback information from the feedback sensor.

17. The method of claim 16, further comprising adjusting the at least one corrective action in response to the feedback information not satisfying the predetermined feedback threshold.

18. The method of claim 13, wherein identifying the one or more corrective actions comprises identifying, by use of at least a machine learning model of a neural network, the one or more corrective actions using at least one of a crop attribute, an environmental attribute, and a machine attribute.

19. The method of claim 13, further comprising identifying at least one operator preference, and wherein the one or more corrective actions are further based, at least in part, on the at least one operator preference.

20. The method of claim 13, further comprising identifying, based on at least the one or more characteristics of the trigger condition, a trigger condition type.
